(19) United States
(12) Patent Application Publication
(10) Pub. No.: US 2025/0133175 A1
(43) Pub. Date: Apr. 24, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: EISUKE NISHITANI, Tokyo (JP)

(21) Appl. No.: 18/922,910

(22) Filed: Oct. 22, 2024

(30) Foreign Application Priority Data
Oct. 23, 2023 (JP) 2023-181865
Jul. 31, 2024 (JP) 2024-124540

(51) Int. Cl. H04N 1/405

(52) U.S. Cl. CPC H04N 1/405

(57) ABSTRACT

An image processing apparatus configured to receive input image data, perform image processing, and output output image data consisting of a plurality of output colors includes a division unit configured to divide the input image data into bands each consisting of continuous rasters, a band group generation unit configured to generate a band group including one or more bands that are continuous, an output color group generation unit configured to divide the plurality of output colors into a plurality of output color groups, and a processing unit configured to perform application processing to apply the image processing to each of the one or more bands included in the band group in a case where an output color group is not changed, wherein the processing unit performs the application processing for each of the output color groups.

### BACKGROUND

### Field of the Disclosure

The present disclosure relates to an image processing technique of inputting image data, performing image processing on the input image data, and outputting output image data including a plurality of output colors.

### Description of the Related Art

There is known a recording apparatus for printing image data serving as input information on a recording medium. As a recording method of the recording apparatus, an ink jet recording apparatus that performs recording using inks, and electrophotographic recording apparatus that performs recording using toners are known. These recording apparatuses, in general, perform image processing on the input image data, convert the processed image data into color information on color materials, such as inks and toners, and record the converted information on a recording medium. In the present disclosure, an ink jet recording apparatus is described, but the application range of the present disclosure is not limited thereto.

The image processing is achieved by hardware or software. In general, it is said that the image processing can be processed faster by image processing dedicated hardware than software. Since the number of circuits of image processing hardware directly affects the cost, various restrictions are imposed thereon in many cases. For example, the number of input/output colors processable by the image processing hardware at one drive is generally limited. Since the present disclosure relates to a driving method of image processing hardware, and hereinafter, a description will be given of only a case where image processing is performed using image processing hardware.

In recent years, from a viewpoint of enhancing image quality, light-color inks, such as light cyan, light magenta, and gray inks, have been sometimes used, in addition to conventionally used four color inks, such as cyan, magenta, yellow, and black inks, as output color inks. Further, a technique for enhancing image quality by processing the same color as different output colors depending on a scan direction of an ink jet head in its reciprocating movement has been developed. In a case where image processing is performed on input image using image processing hardware, as described above, because of the restriction on hardware, there may be a case where the number of colors that can be output is restricted. In this case, if many colors are attempted to be output, there may be a case where the image processing is not completed without performing processing on the input image a plurality of times by the image processing hardware. In such a case, several output colors are grouped to form a color group, and processing is performed by the image processing hardware for each output color group.

In the ink jet recording apparatus, a method of dividing an input image into bands, performing image processing on each band, and outputting an image is often used. In a case where a plurality of times of the processing is performed by the image processing hardware, swapping of output color groups occurs (image processing hardware processing times−1) times to process one band. In a case where the output color groups are swapped, since various setting values need to be swapped many times (described below). Thus, in such a case, the time required for the image processing can be reduced by decreasing the number of times of swapping as much as possible, and the performance of a recording apparatus is improved. On the other hand, there is also a well-known method in which an image in one entire page (all bands) is processed, and thereafter printing is started. With this method, the processing time taken for the image processing can be reduced because the number of times of swapping of the output color groups can be reduced. However, because the printing cannot be started until the image processing for the entire page is completed, there is a disadvantage that a print start operation is delayed.

Japanese Patent Application Laid-open No. 2002-335414 discusses an image processing operation that includes performing band division processing on an input image, and performing luminance-density conversion processing, ink color conversion processing, and quantization processing on the band-divided image. Japanese Patent Application Laid-open No. 2002-335414 discusses reducing time required for the image processing by, in this operation, outputting a value immediately without performing the ink color conversion processing for a specific color and not performing the quantization processing if the corresponding color component is not present.

Japanese Patent Application Laid-open No. 2002-335414 discusses the technique of reducing the time required for the image processing by using the method that does not perform the ink color conversion processing or does not perform the quantization processing depending on the color. However, Japanese Patent Application Laid-open No. 2002-335414 does not discuss a technique of reducing the time required for the image processing in a case where the image processing is completed by repeating the processing a plurality of times by the image processing hardware.

### SUMMARY

According to embodiments of the present disclosure, an image processing apparatus configured to receive input image data, perform image processing, and output output image data consisting of a plurality of output colors includes a division unit configured to divide the input image data into bands each consisting of continuous rasters, a band group generation unit configured to generate a band group including one or more bands that are continuous, an output color group generation unit configured to divide the plurality of output colors into a plurality of output color groups, and a processing unit configured to perform application processing to apply the image processing to each of the one or more bands included in the band group in a case where an output color group is not changed, wherein the processing unit performs the application processing for each of the output color groups.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image processing apparatus according to the present disclosure.

FIG. 2 is a diagram illustrating a division method for input image data according to a conventional example.

FIG. 3 is a diagram illustrating a division method for input image data according to a first exemplary embodiment of the present disclosure.

FIG. 4 is a diagram illustrating a division method for input image data according to a second exemplary embodiment of the present disclosure.

FIGS. 5A and 5B are diagrams illustrating a driving method for an image processing apparatus in a case of performing sequential processing with bands fixed according to a first conventional example.

FIGS. 6A and 6B are diagrams illustrating a driving method for an image processing apparatus in a case of performing sequential processing with output colors fixed according to a second conventional example.

FIGS. 7A and 7B are diagrams illustrating a driving method for an image processing apparatus according to the first exemplary embodiment of the present disclosure.

FIGS. 8A and 8B are diagrams illustrating a driving method for an image processing apparatus according to the second exemplary embodiment of the present disclosure.

FIG. 9 is a diagram illustrating a band group division method according to a third exemplary embodiment of the present disclosure.

FIG. 10 is a comparison diagram illustrating a processing time related to image processing and a time until starting a printing operation according to each of the first conventional example, the second conventional example, the first exemplary embodiment, and the second exemplary embodiment.

### DESCRIPTION OF THE EMBODIMENTS

Embodiments of the present disclosure are directed to a technique for reducing a processing time required for image processing in a case where the image processing is performed by operating image processing hardware a plurality of times.

Hereinbelow, exemplary embodiments will be described with reference to the attached drawings. Note that the exemplary embodiments described below are not intended to limit the disclosure related to the scope of the claims. In the exemplary embodiments, a plurality of features is described, but not all the features are necessarily essential for the present disclosure, and the plurality of features may be arbitrarily combined. Further, in the attached drawings, the same or similar components are assigned the same reference numbers, and the redundant descriptions thereof are omitted.

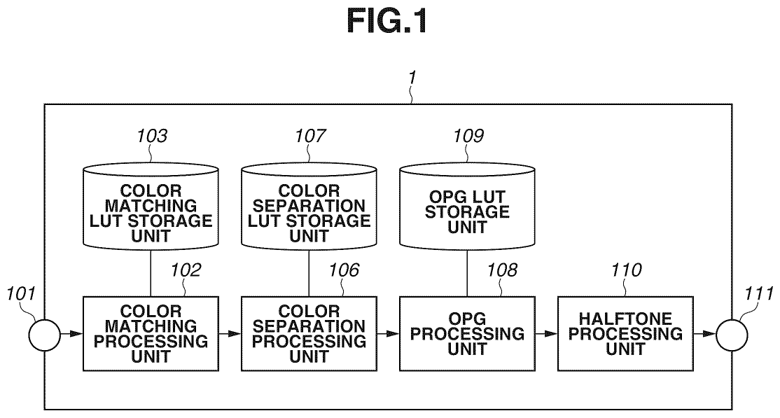

FIG. 1 is a block diagram illustrating a configuration of an image processing apparatus according to the present disclosure. In FIG. 1, an image processing apparatus 1 receives image data representing a print target image via an image data input terminal 101, performs image processing on the image data, and outputs output image data via an output terminal 111. The data output from the output terminal 111 is transmitted to a print processing unit (not illustrated), and the print processing unit starts print processing. Herein, the image data is, for example, color image data including 8-bit red, green, and blue (RGB) image signals. The number of colors of the output data depends on the specification of a recording apparatus. For example, in a case of a recording apparatus with seven color inks mounted thereon, there is known a recording apparatus that outputs cyan, magenta, yellow, black, light cyan, light magenta, and gray data as the output data. Hereinbelow, cyan, magenta, yellow, black, light cyan, light magenta, and gray are abbreviated as C, M, Y, K, Lc, Lm, and Gy, respectively.

Next, a flow of image processing to be performed in the image processing apparatus 1 will be described in detail.

A color matching processing unit 102 performs color matching processing on the acquired image data. When the color matching processing is performed, the color matching processing unit 102 refers to a three-dimensional (3D) color matching look-up table (LUT) stored in a color matching LUT storage unit 103.

Next, a color separation processing unit 106 generates ink-value images from the image data converted by the color matching processing unit 102. When the color separation processing is performed, the color separation processing unit 106 refers to a 3D color separation LUT stored in a color separation LUT storage unit 107.

Next, an output gamma (OPG) processing unit 108 performs gamma-correction processing on the ink value images generated by the color separation processing unit 106. When the OPG processing is performed, the OPG processing unit 108 refers to a one-dimensional (1D) OPG LUT stored in an OPG LUT storage unit 109.

A halftone processing unit 110 performs halftone processing for converting the OPG processed image data into binary data. The halftone processed binary image data is output from the output terminal 111 and transmitted to the print processing unit, and the print processing unit starts print processing.

As described above, since the number of circuits of the image processing apparatus 1 directly affects the cost, various restrictions are imposed thereon in many cases. For example, in most of image processing apparatuses, the number of processable output colors is limited. In the present exemplary embodiment, a description is given of a case where the image processing apparatus 1 can only output up to four colors when the image processing apparatus 1 is driven once. In the recording apparatus with seven color inks (C, M, Y, K, Lc, Lm, and Gy) mounted thereon, in a case where the above-described image processing apparatus 1 is used, the image processing apparatus 1 outputs a four-color group consisting of C, M, Y, and K at the first drive, and a three-color group consisting of Lc, Lm, and Gy at the second drive. A detailed description is given of the case where the image processing apparatus 1 is driven in this way.

In the case where the image processing apparatus 1 outputs the four-color group consisting of C, M, Y, and K at the first drive, the processing is performed as described above. Next, in the case where the image processing apparatus 1 outputs the three-color group consisting of Lc, Lm, and Gy at the second drive, the 3D color matching LUTs that are stored in the color matching LUT storage unit 103 and are to be used by the color matching processing unit 102 are common in both the first processing and the second processing. Accordingly, the LUTs are not to be swapped. On the other hand, the 3D color separation LUTs that are stored in the color separation LUT storage unit 107 and are to be used by the color separation processing unit 106 are to be swapped when the output colors are changed. Similarly, the 1D OPG LUTs that are stored in the OPG LUT storage unit 109 and are to be used by the OPG processing unit 108 are also to be swapped when the output colors are changed. As described above, if the color groups to be processed are changed at the time when the image processing apparatus 1 is driven, swapping processing of the LUTs occurs, and the processing time related to the image processing increases.

Next, a processing method for input image data in a conventional example will be described. A description is given of a case where the image processing apparatus 1 with output colors limited up to four colors is used in the ink jet recording apparatus with the seven color inks (C, M, Y, K, Lc, Lm, and Gy) mounted thereon described above.

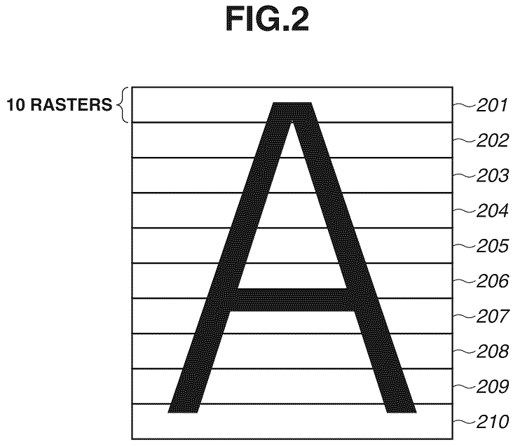

In a case where a method of recording while performing serial scanning by an ink jet recording head is used in the ink jet recording apparatus, there is a known method of repeating the operation of performing image processing on a part of input image data, transferring output data to the ink jet recording head, and performing printing. In the case of this method, a method of dividing input image data into units of band composed of continuous rasters to perform image processing is used in many cases. FIG. 2 illustrates a division method for input image data according to the conventional example. As illustrated in FIG. 2, continuous ten rasters are set as one band, the input image data is divided into 10 bands 201 to 210, and the image processing is performed on each band.

Next, a processing method for the 10 bands 201 to 210 will be described.

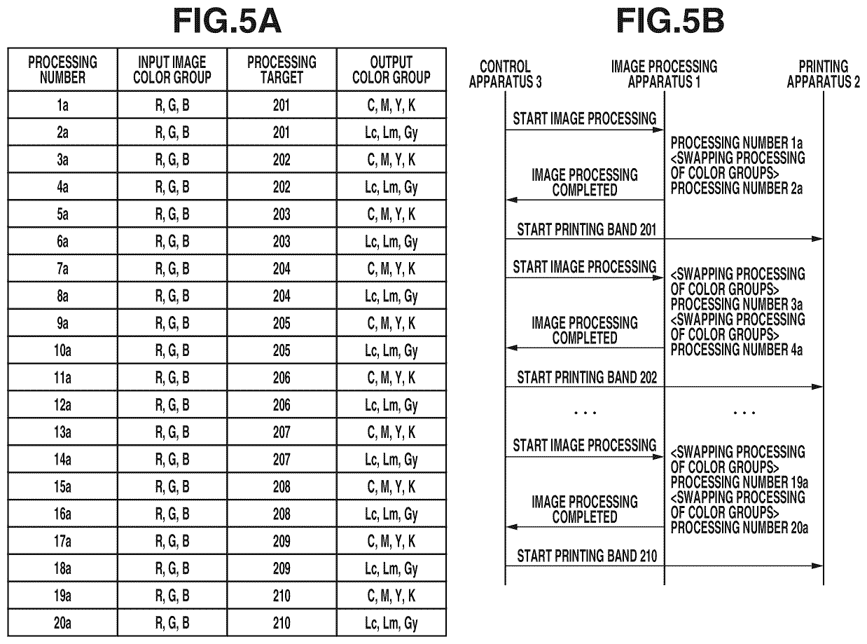

A band processing method according to a first conventional example is illustrated in FIG. 5A. The band processing method is a method of processing input image data with bands fixed, in which the bands are processed sequentially from one to the next. First, in a processing number 1a, the band 201 located at a leading end of the image is processed. In the processing number 1a, the input image colors are set to R, G, and B, and the image processing apparatus 1 performs processing so as to output a four-color group consisting of C, M, Y, and K. Subsequently, in a processing number 2a, a color group to be output is swapped to a color group of Lc, Lm, and Gy. In other words, the image processing apparatus 1 performs processing to output the color group of three colors consisting of Lc, Lm, and Gy, using the input image colors of R, G, and B. When the processing in the processing number 1a and the processing number 2a is performed, the output of the band 201 is completed. Accordingly, the image processing apparatus 1 can start the printing operation by transmitting the output data to the print processing unit. Similarly, when processing in a processing number 3a and a processing number 4a is performed, the output of the band 202 is completed, and the printing corresponding to the band 202 can be performed.

Next, with reference to FIG. 5B, a processing sequence according to the first conventional example will be described. When a control apparatus 3 that controls a printing apparatus 2 (ink jet recording apparatus) instructs the image processing apparatus 1 to start image processing, the image processing is started. In the first image processing, the processing in the processing number 1a and the processing number 2a is performed.

However, the output color groups are different between the processing number 1a and the processing number 2a, and the swapping processing of the color groups are to be performed. When the processing in the processing number 1a, the swapping processing of the output color groups, and the processing in the processing number 2a are completed, the band 201 is ready for being printed. Since the image processing on the band 201 has been completed, the control apparatus 3 instructs the printing apparatus 2 to start printing the band 201, and the printing apparatus 2 starts printing.

As illustrated in FIG. 5B, the swapping processing of the output color groups are to be performed 19 times in total, and the overall processing speed becomes slow due to the swapping processing of the output color groups.

With the band processing method in FIGS. 5A and 5B, since the output data can be completed every two processes, it is possible to reduce the time until the printing operation is started. However, with the band processing method in FIGS. 5A and 5B, since the swapping of the output color groups occurs every time the processing changes as described above, the swapping processing of the LUTs occurs due to the swapping of the color groups. Accordingly, there is a disadvantage that the processing time related to the image processing increases.

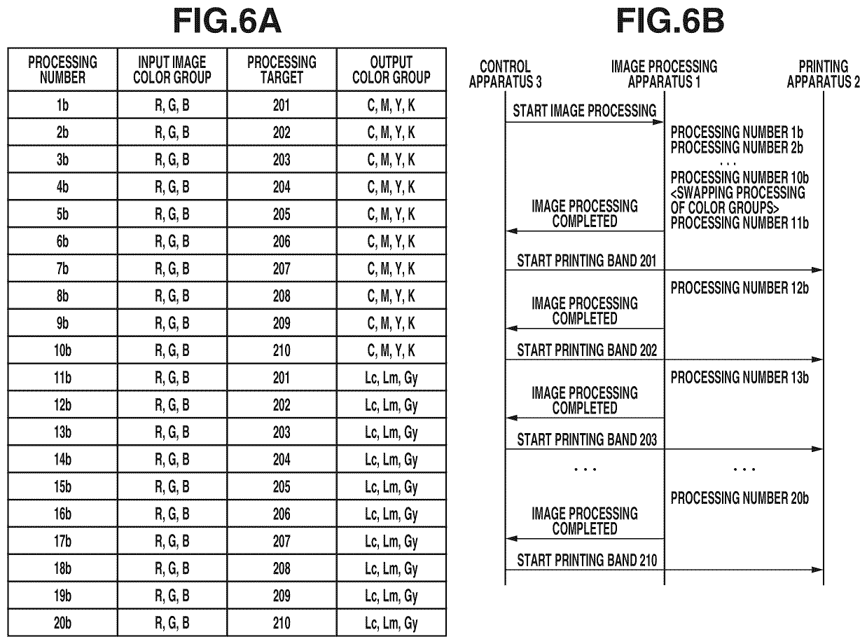

On the other hand, as a driving method for the image processing apparatus, there is also a method of processing input image data with output color groups fixed, in which the processing is performed for each of the output color groups sequentially from one to the next. As a second conventional example, the method will be described with reference to FIGS. 6A and 6B. Similar to the case in FIGS. 5A and 5B, in a processing number 1b, the image processing apparatus 1 performs processing on the band 201 to output a four-color group consisting of C, M, Y, and K. Next, in a processing number 2b, the image processing apparatus 1 changes the processing target to the band 202, and performs processing on the band 202 to output the four-color group consisting of C, M, Y, and K. If the processing is continuously performed in this manner until the processing is completed up to a processing number 10b, the processing for the four-color group consisting of C, M, Y, and K is completed. Next, in a processing number 11b, the output color group is swapped to the output color group of Lc, Lm, and Gy, the processing target is changed back to the band 201, and the image processing apparatus 1 performs processing. When the processing is completed up to the processing number 11b, the output of the band 201 is completed. Next, in a processing number 12b, the processing target is changed to the band 202, and the image processing apparatus 1 similarly performs processing to output the three-color group consisting of Lc, Lm, and Gy. When the processing is completed up to the processing number 12b, the output of the band 202 is completed. When the same processing is repeated up to a processing number 20b, the processing on the input image data is completed.

Next, with reference to FIG. 6B, a processing sequence according to the second conventional example will be described. When the control apparatus 3 that controls the printing apparatus 2 (ink jet recording apparatus) instructs the image processing apparatus 1 to start image processing, the image processing is started. In the first image processing, the processing in the processing number 1b to the processing number 20b is performed. Since the output color groups in the processing number 1b to the processing number 10b are the same, the swapping processing of the color groups does not occur. Since the output color group changes between the processing number 10b and the processing number 11b, the swapping processing of the output color groups is to be performed. Since the output color groups in the processing number 11b to the processing number 20b are the same, the swapping processing of the color groups does not occur.

However, since the printing apparatus 2 cannot start printing until the image processing apparatus 1 completes the processing for all the output colors (C, M, Y, K, Lc, Lm, and Gy), the control apparatus 3 needs to wait for the processing on the band 201 to be completed, i.e., until the processing up to the processing number 11b is completed in order to be ready for printing. Upon completing the processing up to the processing number 11b, the control apparatus 3 instructs the printing apparatus 2 to perform print processing on the band 201, and then the printing apparatus 2 can start printing the band 201. Similarly, upon completing the processing up to the processing number 12b, the control apparatus 3 instructs the printing apparatus 2 to perform print processing on the band 202, and then the printing apparatus 2 can start printing the band 202. The printing up to the band 210 is performed by repeating the similar processing described above.

In the band processing method in FIGS. 6A and 6B, since the processing of the band 201, which is the leading end of the image, is not completed until the processing in the processing number 11b is completed, the time until the printing operation starts increases compared to the band processing method in FIGS. 5A and 5B. On the other hand, since the swapping processing of the output color groups occurs only once between the processing number 10b and the processing number 11b, the swapping processing of the LUTs due to the swapping of the color groups occurs less often, which is an advantage to reduce the processing time related to the image processing.

As described above, the method of processing the input image data with the bands fixed, in which the bands are processed sequentially from one to the next, as in the first conventional example illustrated in FIGS. 5A and 5B can reduce the time until the printing operation is started, whereas the processing time related to the image processing increases. On the other hand, the method of processing the input image data with the output color groups fixed, in which the processing is performed for each of the output color groups sequentially from one to the next, can reduce the processing time related to the image processing as in the second conventional example illustrated in FIGS. 6A and 6B, whereas the time until the printing operation is started increases. In this manner, a trade-off relationship occurs between the two conventional examples.

Hereinbelow, a first exemplary embodiment of the present disclosure will be described with reference to the drawings.

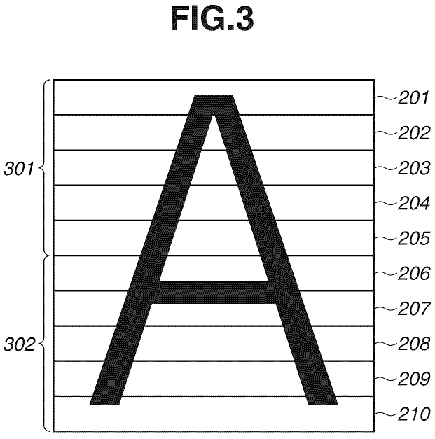

FIG. 3 illustrates a division method for input image data according to the first exemplary embodiment. The bands 201 to 205 are combined into a band group 301, and the bands 206 to 210 are combined into a band group 302. The outline of processing is as follows. Roughly, the band group 301 and the band group 302 are processed in this order. With this processing, when the processing on the band group 301 is completed, the output of the bands 201 to 205 is completed, and the printing operation can be started. On the other hand, the processing on the bands 201 to 205 in the band group 301 is performed using the method of processing the input image data with the output color groups fixed, in which the processing is performed for each of the output color groups sequentially from one to the next. In this way, it is possible to reduce both the processing time related to the image processing, and the time until the printing operation is started.

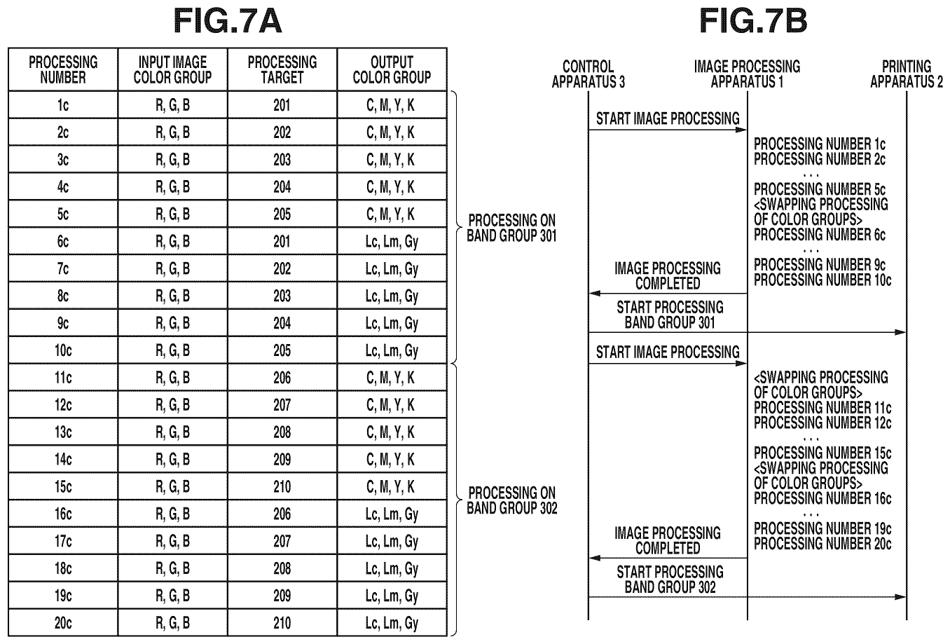

With reference to FIG. 7A, a driving method for the image processing apparatus 1 according to the first exemplary embodiment will be described in more detail. The processing in a processing number 1c to a processing number 10c is processing on the band group 301, the processing in a processing number 11c to a processing number 20c is processing on the band group 302. In the processing number 1c, the image processing apparatus 1 performs processing on the band 201 to output the four-color group consisting of C, M, Y, and K. In the processing number 1c to the processing number 5c, the output color groups are fixed to the four-color group consisting of C, M, Y, and K, and the image processing apparatus 1 performs processing while moving from the band 201 to the band 205. In the processing number 6c, the image processing apparatus 1 changes the processing target back to the band 201, swaps the output color group to the output color group of Lc, Lm, and Gy and performs the image processing. When the processing up to the processing number 6c is completed, the image processing on the band 201 is completed, and the printing apparatus 2 can start the printing operation for the band 201. Similarly, when the processing up to the processing number 10c is completed, the processing on the band group 301 is completed, and the output of the bands 201 to 205 is completed.

Next, in the processing number 11c, the image processing apparatus 1 changes the output color group to the output color group of C, M, Y, and K, and performs the processing on the band 206. Then, in the processing number 11c to the processing number 15c, the output color groups are fixed to the output color group of C, M, Y, and K, and the image processing apparatus 1 performs the processing while moving from the bands 206 to 210. In the processing number 16c, the image processing apparatus 1 changes the output color group to the output color group of Lc, Lm, and Gy, and performs the image processing on the band 206. Similarly, in the processing number 16c to the processing number 20c, the output color group is fixed to the output color group of Lc, Lm, and Gy, and the image processing apparatus 1 performs the processing while moving from the bands 206 to 210. When the processing in the processing number 20c is completed, the processing on the input image is completed.

Next, with reference to FIG. 7B, a processing sequence according to the present exemplary embodiment will be described. When the control apparatus 3 that controls the printing apparatus 2 (ink jet recording apparatus) instructs the image processing apparatus 1 to start image processing, the image processing apparatus 1 starts the image processing. In the first image processing, the processing of the processing number 1c to the processing number 10c is performed. Since the output color groups in the processing number 1c to the processing number 5c are the same, the swapping processing of the color groups does not occur.

Since the output color group changes between the processing number 5c and the processing number 6c, the swapping processing of the output color groups is to be performed. Since the output color groups in the processing number 6c to the processing number 10c are the same, the swapping processing of the output color groups does not occur. When the processing up to the processing number 10c is completed, the control apparatus 3 instructs the printing apparatus 2 to perform the print processing on the band group 301, so that the printing apparatus 2 can start printing the bands 201 to 205.

Similarly, when the processing up to the processing number 20c is completed, the control apparatus 3 instructs the printing apparatus 2 to perform the print processing on the band group 302, so that the printing apparatus 2 can start performing the print processing on the bands 206 to 210.

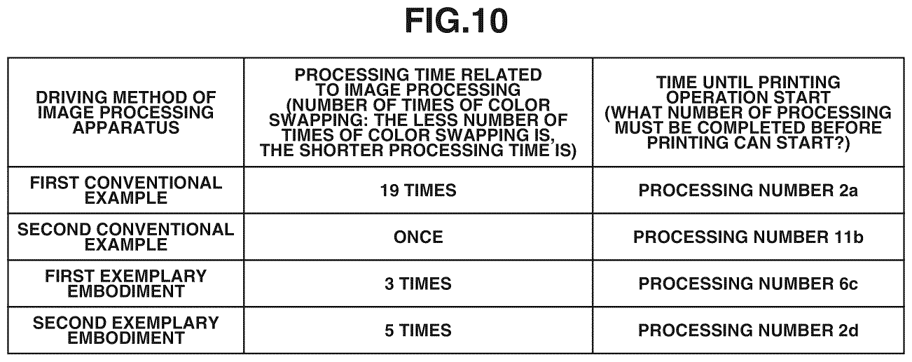

FIG. 10 is a comparison table illustrating the processing time related to the image processing and the time until the start of the printing operation in each of the first conventional example, the second conventional example, the first exemplary embodiment, and the second exemplary embodiment. In the first conventional example, since the bands are fixed and the processing of swapping the color groups is sequentially performed, the number of times of the swapping processing of the LUTs increases to 19 times, whereas the printing operation can be started when the processing in the processing number 2a is completed. On the other hand, in the second conventional example, since the color groups are fixed and the swapping processing of the bands is sequentially performed, the number of times of swapping the LUTs is only once, whereas the printing operation cannot be started until the processing in the processing number 11b is completed. In the first exemplary embodiment according to the present disclosure, the color groups are fixed, and the swapping processing of the bands is performed as in the second conventional example within a band. In this way, the number of times of the swapping of the LUTs can be reduced to 3, and the printing operation can be started when the processing in the processing number 6c is completed. As a result, the printing operation can be started earlier in the first exemplary embodiment than in the second conventional example. On the other hand, when the first exemplary embodiment is compared with the first conventional example, the printing operation can be started after the processing in the processing number 6c is performed in the first exemplary embodiment, which is a bit later than the start of the printing operation in the first conventional example. However, the number of times of the swapping of the LUTs can be significantly reduced to 3, and the processing time related to the image processing can be reduced, as compared to the first conventional example.

Hereinbelow, a second exemplary embodiment of the present disclosure will be described with reference to the drawings.

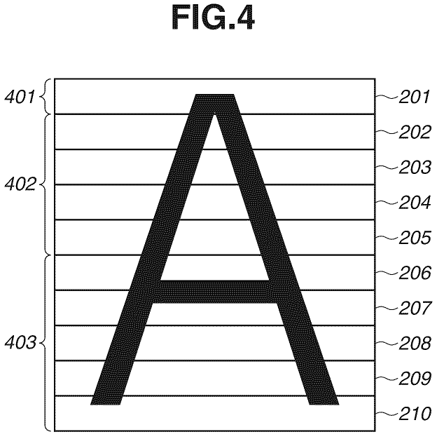

FIG. 4 illustrates a division method for input data according to the second exemplary embodiment. Similar to the first exemplary embodiment, in the present exemplary embodiment, the image data is also divided into band groups and processed for each band group. It is characterized that, when the number of bands included in a band group is increased, the processing time related to the image processing is reduced, but the start of the printing operation for each band included in the band group becomes delayed. In the present exemplary embodiment, the number of bands included in a band group is increased in order of a band group 401, a band group 402, and a band group 403. In a case where the printing operation is desired to start earlier, the number of bands included in a band group (band group 401 in the present exemplary embodiment) located at the leading end of the image is reduced. Then, when output information required for the printing operation is sufficiently acquired, the number of bands included in the band group is gradually increased, and the number of bands is set so as to reduce the processing time related to the image processing.

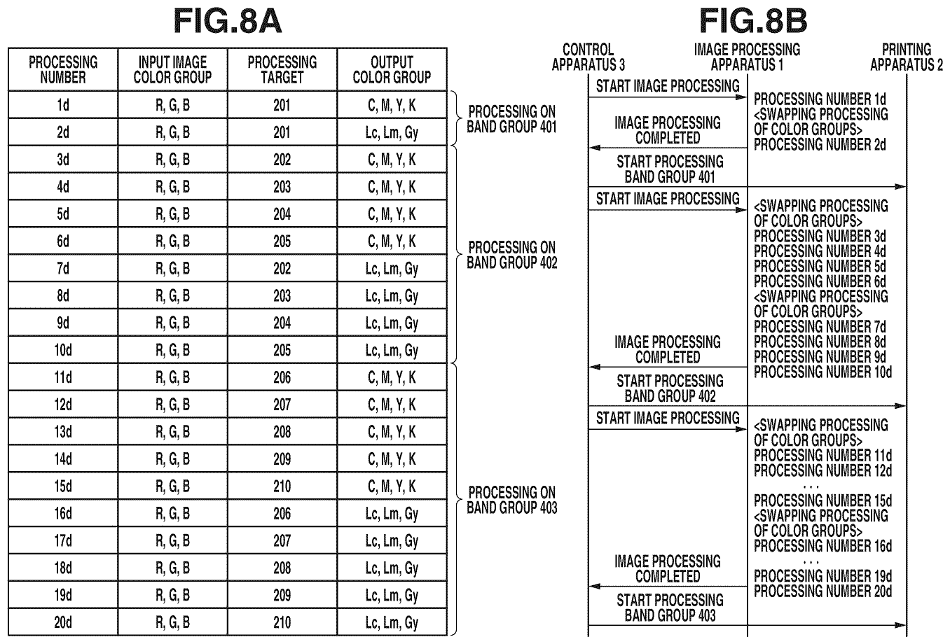

With reference to FIG. 8A, a driving method for the image processing apparatus 1 according to the second exemplary embodiment will be described in more detail. In the present exemplary embodiment, the number of the bands included in the band group 401 is only one, i.e., the band 201. The number of bands included in the band group 402 is four, i.e., the bands 202 to 205. The number of bands included in the band group 403 is five, i.e., the bands 206 to 210. As described above, as the band group is located farther from the leading end of the image, the number of bands included in the band group is increased. In the present exemplary embodiment, when the processing up to a processing number 2d is completed, the processing on the band 201 is completed, and the printing operation for the band 201 can be started.

Subsequently, the processing on the band group 402 is performed. In this case, the processing on four bands consisting of the bands 202 to 205 is performed. While the printing operation for the output data of the band group 401 is being performed, the processing on the band group 402 is performed, and the number of bands included in the band group 402 is adjusted so as to be in time for the next printing operation. Similarly, while the printing operation for the output data of the band group 401 and the band group 402 is being performed, the processing on the band group 403 is performed, and the number of bands included in the band group 403 is adjusted so as to be in time for the next printing operation.

Next, with reference to FIG. 8B, a processing sequence according to the present exemplary embodiment will be described. When the control apparatus 3 that controls the printing apparatus 2 (ink jet recording apparatus) instructs the image processing apparatus 1 to start image processing, the image processing is started. In the first image processing, the processing in a processing number 1d and the processing number 2d is performed. Since the output color group changes between the processing number 1d and the processing number 2d, the swapping processing of the output color groups is to be performed. When the processing in the processing number 1d, the swapping processing of the color groups, and the processing in the processing number 2d are completed, the image processing on the band group 401 (i.e., the band 201) is completed. Accordingly, the control apparatus 3 instructs the printing apparatus 2 to start the printing of the band group 401, and the printing apparatus 2 can start performing print processing on the band 201.

Subsequently, in the second image processing, the processing in a processing number 3d to a processing number 10d is performed. In the present exemplary embodiment, the second processing corresponds to eight pieces of processing in a processing number 3d to a processing number 10d, but the number of the pieces of processing in the second processing is not limited to eight and may only need to be more than or equal to the number of the pieces of processing in the first processing. Since the output color group changes between a processing number 6d and a processing number 7d, the swapping processing of the output color groups is to be performed. When the processing in the processing number 3d to the processing number 6d, the swapping processing of the output color groups, and the processing in the processing number 7d to the processing number 10d are completed, the image processing on the band group 402 is completed. Accordingly, the control apparatus 3 instructs the printing apparatus 2 to perform the print processing on the band group 402, i.e., the bands 202 to 205, and the printing apparatus 2 can start printing the band group 402.

Similarly, in the third image processing, the swapping processing of the output color groups, the processing in a processing number 11d to a processing number 15d, the swapping processing of the output color groups, and the processing in a processing number 16d to the processing in a processing number 20d are performed, and when the processing is completed, the control apparatus 3 instructs the printing apparatus 2 to perform print processing on the band group 403, i.e., the bands 206 to 210. As a result, the printing of the band group 403 can be started. In the third image processing, 10 pieces of processing in the processing number 11d to the processing number 20d are performed in the second processing, but the number of pieces of processing in the third processing is not limited to 10 and may only need to be more than or equal to the number of pieces of processing in the second processing.

In the present exemplary embodiment, the number of bands included in a band group is increased as the band group is located farther from the leading end of the image, so as to satisfy the relationship of (the number of bands included in the band group 401)<(the number of bands included in the band group 402)<(the number of bands included in the band group 403), but the relationship may include an equal sign. More specifically, (i-th band group from the leading end of the image)≤((i+1)-th band group) may be appropriate.

Hereinbelow, a third exemplary embodiment according to the present disclosure will be described.

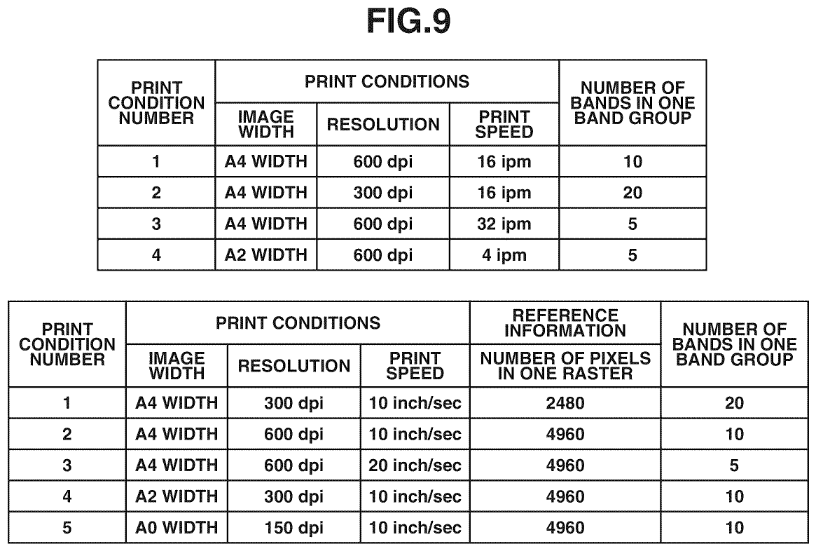

In the present exemplary embodiment, with reference to FIG. 9, a band group division method in which the number of bands included in a band group is changed depending on print conditions will be described.

In a case where the method proposed in the present disclosure is used, since the image processing speed on a band varies depending on the print conditions, it is possible to select suitable conditions from among various print conditions by changing the number of bands included in a band group depending on the print conditions.

FIG. 9 illustrates an example where the number of bands included in a band group is changed depending on the print conditions, such as an image width, a resolution, and a print speed. In addition, in the conditions in the print condition numbers illustrated in FIG. 9, all the band heights are set to be 10 rasters. In the conditions in a print condition number 1, in a case where the image width is an A4 width, the resolution is 600 dots per inch (dpi), and the print speed is 16 inch per minute (ipm), the number of bands in a band group is 10. In the conditions in a print condition number 2, the image width is an A4 width, the resolution is 300 dpi, and the print speed is 16 ipm.

In the conditions in the print condition number 2, as compared to the print condition number 1, the resolution is reduced from 600 dpi to 300 dpi, and the number of pixels per band is thus half of that in the print condition number 1. Accordingly, to meet the same print speed 16 ipm, the number of bands in a band group is increased to 20.

The print speed in a print condition number 3 is twice faster (from 16 ipm to 32 ipm) than that in the print condition number 1. Accordingly, the number of bands in a band group is reduced to 5 in order to process the band group at the same speed as that in the print condition number 1 even in the conditions in the print condition number 3.

The image width in a print condition number 4 is twice greater (from A4 to A2) than that in the print condition number 1, and on the other hand, the print speed is ¼ (from 16 ipm to 4 ipm) of that in the print condition number 1. The printable areas per unit time in the print condition number 4 and the print condition number 1 are the same. Since the image width in the print condition number 4 is twice greater than that in the print condition number 1, the number of bands in a band group is set to be half (5) of that in the print condition number 1.

As described above in the present exemplary embodiment, by changing the number of bands in a band group depending on the print conditions, the processing time related to the image processing can be reduced, and the printing operation can be started without delay.

In the present exemplary embodiment, an image width, a resolution, and a print speed are described as examples of the print conditions, but the print conditions here are not limited thereto. For example, a print mode of color/monochrome, the number of inks to be used, the number of nozzles of an ink jet head, and the number of pulses in a case where multi-pass printing is performed to enhance the quality in a serial printer are also applicable to the print conditions. Further, conditions for operating a recording apparatus, such as preliminary discharge intervals of an ink jet head are also applicable to the print conditions.

The present disclosure can be realized by the processing of supplying a program for implementing one or more functions of the above-described exemplary embodiments to a system or an apparatus via a network or a storage medium and causing one or more processors in a computer in the system or the apparatus to read and execute the program. Further, the present disclosure can also be realized by circuits (e.g., application specific integrated circuits (ASICs)) that can implement one or more functions.

The present disclosure includes the following configurations and method.

### Configuration 1

An image processing apparatus configured to receive input image data, and perform image processing, and output output image data consisting of a plurality of output colors, including,
a division unit configured to divide the input image data into bands each consisting of continuous rasters,
a band group generation unit configured to generate a band group including one or more bands, the one or more bands being continuous,
an output color group generation unit configured to divide the plurality of output colors into a plurality of output color groups, and
a processing unit configured to perform application processing to apply the image processing to each of the one or more bands included in the band group in a case where an output color group is not changed,
wherein the processing unit performs the applied processing on each of the output color groups.

### Configuration 2

The image processing apparatus according to Configuration 1, wherein a number of bands included in the band group is changed depending on a print condition set in the input image data.

### Configuration 3

The image processing apparatus according to Configuration 2, wherein the print condition is an image width an image represented by the input image data.

### Configuration 4

The image processing apparatus according to Configuration 2, wherein the print condition is a resolution of an image represented by the input image data.

### Configuration 5

The image processing apparatus according to any one of Configurations 2 to 4, wherein the print condition is a print speed when the input image data is printed.

### Configuration 6

The image processing apparatus according to Configuration 1, wherein the number of bands included in the band group is changed depending on a plurality of combinations of print conditions.

### Configuration 7

The image processing apparatus according to any one of Configurations 1 to 6, wherein in a case where a plurality of band groups is rearranged in order nearer to a leading end of the input image data, a number of the bands included in an (i+1)-th band group is larger than a number of bands included in an i-th band group.

### Configuration 8

A program for causing a computer to function as units of the image processing apparatus according to any one of Configurations 1 to 7.

### Configuration 9

An image processing method including,
inputting input image data,
performing image processing,
outputting output image data consisting of a plurality of output colors,
dividing the input image data into bands each consisting of continuous rasters,
generating a band group including one or more bands, the one or more bands being continuous,
dividing the plurality of output colors into a plurality of output color groups, and
performing application processing to apply the image processing to each of the one or bands included in the band group in a case where an output color group is not changed,
wherein the application processing is performed for each of the output color groups.

According to the present disclosure, in the case where image processing is completed by repeating processing by image processing hardware a plurality of times, it is possible to reduce time required for the image processing without delaying a print start operation. Therefore, a recording apparatus with an image processing apparatus mounted thereon can improve the performance as a recording apparatus because processing time usable for other than the image processing apparatus increases.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-181865, filed Oct. 23, 2023, and No. 2024-124540, filed Jul. 31, 2024, which are hereby incorporated by reference herein in their entirety.

What is claimed is:

1. An image processing apparatus configured to receive input image data, perform image processing, and output output image data consisting of a plurality of output colors, the image processing apparatus comprising:
a division unit configured to divide the input image data into bands each consisting of continuous rasters;
a band group generation unit configured to generate a band group including one or more bands, the one or more bands being continuous;
an output color group generation unit configured to divide the plurality of output colors into a plurality of output color groups; and
a processing unit configured to perform application processing to apply the image processing to each of the one or more bands included in the band group in a case where an output color group is not changed,
wherein the processing unit performs the application processing for each of the output color groups.

2. The image processing apparatus according to claim 1, wherein a number of bands included in the band group is changed depending on a print condition set in the input image data.

3. The image processing apparatus according to claim 2, wherein the print condition is an image width of an image represented by the input image data.

4. The image processing apparatus according to claim 2, wherein the print condition is a resolution of an image represented by the input image data.

5. The image processing apparatus according to claim 2, wherein the print condition is a print speed when the input image data is printed.

6. The image processing apparatus according to claim 2, wherein a number of bands included in the band group is changed depending on a plurality of combinations of print conditions.

7. The image processing apparatus according to claim 1, wherein in a case where a plurality of band groups is rearranged in order from a band group nearer to a leading end of the input image data, a number of bands included in an (i+1)-th band group is larger than a number of bands included in an i-th band group.

8. A non-transitory computer-readable storage medium storing instructions that, when executed by a computer, cause the computer to perform an image processing method, the image processing method comprising:
inputting input image data;
performing image processing;
outputting output image data consisting of a plurality of output colors;
dividing the input image data into bands each consisting of continuous rasters;
generating a band group including one or more bands, the one or more bands being continuous;
dividing the plurality of output colors into a plurality of output color groups; and
performing application processing to apply the image processing to each of the one or more bands included in the band group in a case where an output color group is not changed,
wherein the application processing is performed for each of the output color groups.

9. An image processing method, comprising:
inputting input image data;
performing image processing;
outputting output image data consisting of a plurality of output colors;
dividing the input image data into bands each consisting of continuous rasters;
generating a band group including one or more bands, the one or more bands being continuous;
dividing the plurality of output colors into a plurality of output color groups; and
performing application processing to apply the image processing to each of the one or more bands included in the band group in a case where an output color group is not changed,
wherein the application processing is performed for each of the output color groups.
